(19) United States
(12) Patent Application Publication
(10) Pub. No.: US 2017/0318592 A1
(43) Pub. Date: Nov. 2, 2017

(54) D2D Interference Coordination Methods and Apparatuses, Base Station and User Equipment

(71) Applicant: ZTE Corporation, Shenzhen (CN)

(72) Inventors: Li CHU, Shenzhen (CN); Lin CHEN, Shenzhen (CN)

(21) Appl. No.: 15/518,033

(22) PCT Filed: Jun. 24, 2015
(86) PCT No.: PCT/CN2015/082231

§ 371 Date: Apr. 10, 2017

(30) Foreign Application Priority Data
Oct. 9, 2014 (CN) 201410529443.X

(51) Int. Cl. H04W 72/08; H04L 1/00; H04W 72/04

(52) U.S. Cl. CPC H04W 72/082; H04W 72/0426; H04L 1/0027; H04W 72/0473

(57) ABSTRACT

Device-to-Device (D2D) interference coordination methods and apparatuses, a base station, and a User Equipment (UE) are provided. A base station acquires D2D transmission Tx power information (S302). The D2D transmission Tx power information is used for indicating Tx power of D2D transmission to be scheduled over a corresponding radio resource or indicating power information causing interference to D2D transmission over a corresponding radio resource. The base station conducts interference coordination processing according to the D2D transmission Tx power information (S304).

### TECHNICAL FIELD

The present disclosure relates to the field of communications, and in particular to Device-to-Device (D2D) interference coordination methods and apparatuses, a base station, and a User Equipment (UE).

### BACKGROUND

With the development of wireless multimedia services, demands of people for high data rate and good user experience are increasing, thereby raising a higher requirement for system capacity and coverage of a traditional cellular network. In another aspect, due to application scenarios such as public security, social networking, near-field data sharing and local advertising, demands of people for getting to know and further communicating (via proximity services) with surrounding people or things are increasing. The traditional cellular network mainly based on base stations (may be embodied as evolved node B (eNB)) has obvious limitations in supporting of high data rate and proximity services. Facing these demands, a D2D technology representative of a new development direction of a future communication technology emerges. Application of the D2D technology can alleviate burdens to the cellular network, reduce the power consumption of a battery of a User Equipment (UE), increase the data rate, improve the robustness of a network infrastructure, and well meet the requirements for the high data rate services and the proximity services.

The D2D technology can work on a licensed band or unlicensed band to allow a plurality of D2D UEs supporting a D2D function to perform direct discovery and/or direct communication in the presence or absence of a network infrastructure. There are mainly three D2D application scenarios.

(1) UE1 and UE2 perform data interaction under the coverage of a cellular network, while user plane data does not pass through the network infrastructure, as Mode 1 in FIG. 1.

(2) Relay transmission is performed for a UE in a weak-coverage/non-coverage area, as Mode 2 in FIG. 1. UE4 poor in signal quality is enabled to communicate with a network by means of a UE3 nearby which is in the coverage of the network. By virtue of this mode, an operator can be assisted in coverage expansion and capacity increase.

(3) When a cellular network cannot normally work in case of an earthquake or emergency, direct communication between devices is enabled, as mode 3 in FIG. 1. UE5, UE6 and UE7 can perform one-hop or multi-hop data communication in both the control plane and the user plane without a network infrastructure.

The D2D technology usually includes a D2D discovery technology and a D2D communication technology.

(1) The D2D discovery technology refers to a technology for judging/determining proximity between two or more D2D UEs (e.g., within a range of D2D direct communication) or for judging/determining proximity between a first UE and a second UE.

(2) The D2D communication technology refers to a technology for direct communication of some or all communication data between D2D UEs

Before conducting D2D discovery or D2D communication, a D2D UE needs to acquire corresponding radio resources first. There are generally two modes for assigning resources for D2D discovery or D2D communication. A first resource assignment mode is to acquire resources for D2D discovery/communication based on contention-based resource acquisition. A second resource assignment mode is to assign dedicated resources for D2D discovery/communication to a UE by a base station. In the first resource assignment mode, a base station or a system usually pre-assigns a D2D resource pool, and a D2D UE participating in D2D discovery/communication monitors the resource pool and acquires D2D transmission resources in a contention manner. This mode may be mainly applied to a D2D UE out of coverage of a cellular network, and may also be applied to a D2D UE within the coverage of the cellular network. A D2D contention resource pool configured by the serving cell of the D2D UE may be used for the D2D UE within the coverage of the cellular network. A pre-configured D2D contention resource pool may be used for the D2D UE out of coverage of the cellular network. In the second resource assignment mode, appropriate D2D resources are assigned to the D2D UE. This mode may be applied only to the D2D UE within the coverage of the cellular network.

For D2D discovery and D2D communication, if the D2D UE within the coverage of the cellular network acquires resources in a contention-based resource acquisition mode, a D2D resource pool may be obtained from the base station first, and then the D2D UE may select resources for D2D transmission from the resource pool in a contention manner.

Generally, D2D transmission and cellular transmission share resources. D2D resources between neighbour cells may be identical or may be different. A scenario in which the D2D transmission and the cellular transmission between the neighbour cells co-exist is as shown in FIG. 2. In this example, UE1 and UE2 are subordinate to a base station eNB1, UE3, UE4 and UE5 are subordinate to a base station eNB2, and these UEs are located in edge areas of their respective cells. UE1 conducts D2D transmission (signal transmission of D2D discovery or D2D communication) under eNB1, and UE2 and UE3 are conducting corresponding D2D monitoring or receiving the D2D transmission of UE1. UE4 conducts D2D transmission under eNB2, and UE5 is conducting corresponding D2D monitoring or receiving the D2D transmission of UE4. If eNB1 and eNB2 assign the same D2D resources to UE1 and UE4, D2D transmission on UE1 and UE4 may interfere with each other. If UE3 expects to monitor or receive the D2D transmission of both UE1 and UE4, normal monitoring or receiving cannot be conducted by a UE only having a half-duplex capability due to a conflict of D2D resources between UE1 and UE4.

Under a condition that UE4 conducts cellular transmission, if cellular transmission resources assigned to UE4 by eNB2 are identical to D2D transmission resources assigned to UE1 by eNB1, the cellular transmission of UE4 may interfere with the D2D transmission of UE1.

Generally, uplink resources of cellular communication are commonly adopted for the D2D transmission, so interference between the D2D transmission and the cellular transmission mainly includes interference between the D2D transmission and cellular uplink transmission. If downlink resources of the cellular communication are also adopted for the D2D transmission, interference between the D2D transmission and cellular downlink transmission may also exist.

Interference coordination based on power limitation is conducted via interaction between cells in order to solve the problem of mutual interference of cellular transmission of neighbour cells in the related art.

In this method, a Relative Narrowband Tx Power (RNTP) mechanism is adopted. A downlink power limitation of each Resource Block (RB) and other information for interference coordination scheduling for neighbour cells (also referred to as inter cells) are provided to a neighbour base station in a list form. A bitmap is adopted to indicate whether the Tx power of a corresponding downlink RB will exceed an RNTP threshold within a future period of time. The corresponding RNTP threshold is also provided in the list.

The inventors discover, in a research process, that targeted information for D2D transmission cannot be provided in the related art, and the related art is also unable to distinguish which information is associated with interference between cellular communications and which information is associated with D2D transmission. Since degrees of load of D2D transmission resources and cellular transmission resources are different, and a policy and priority for D2D transmission are different from those for cellular transmission according to different practical applications, different considerations should be made for corresponding interference processing and scheduling. So, a targeted solution is needed for the problem of interference or resource conflict resulted from the D2D transmission between cells. Failing to provide such targeted solution may greatly affect the effects of D2D transmission and cellular transmission, thus resulting in reduction of receiving performance and severely affecting the user experience of relevant services.

No effective solution has been proposed yet at present for the problem of reduced receiving performance of D2D transmission and cellular transmission due to interference or resource conflict resulted from D2D transmission between cells in the related art.

### SUMMARY

Some embodiments of the present disclosure provide D2D interference coordination methods and apparatuses, a base station and a user equipment, to at least solve the problem of reduced receiving performance of D2D transmission and cellular transmission due to interference or resource conflict resulted from D2D transmission between cells.

According to an aspect of the embodiments of the present disclosure, a D2D interference coordination method is provided. In the D2D interference coordination method, a base station acquires D2D transmission Tx power information, and the base station conducts interference coordination processing according to the D2D transmission Tx power information. The D2D transmission Tx power information is used for indicating Tx power of D2D transmission to be scheduled over a corresponding radio resource or indicating power information causing interference to D2D transmission over a corresponding radio resource.

In an exemplary embodiment, the act that the base station acquires the D2D transmission Tx power information may include at least one of the following acts. The base station receives the D2D transmission Tx power information sent by a UE or a neighbour base station. The base station generates the D2D transmission Tx power information according to an interference condition of radio resources.

In an exemplary embodiment, the D2D transmission Tx power information may include at least one of: valid time of the D2D transmission Tx power information or time of duration of the D2D transmission, a group identifier of the D2D transmission, a priority of the D2D transmission, or resource information corresponding to the D2D transmission.

In an exemplary embodiment, the act that interference coordination processing is conducted according to the D2D transmission Tx power information may include at least one of the following acts. The base station conducts power limitation adjustment or resource scheduling adjustment for the D2D transmission according to the D2D transmission Tx power information. The base station sends the D2D transmission Tx power information to a neighbour base station of the base station. The base station sends the D2D transmission Tx power information to a processing centre.

In an exemplary embodiment, the act that the base station conducts resource scheduling adjustment for the D2D transmission according to the D2D transmission Tx power information may include acts as follows. The base station determines whether the Tx power of the D2D transmission exceeds a first preset value according to the D2D transmission Tx power information, or determines a grade of the Tx power of the D2D transmission according to the D2D transmission Tx power information. When the Tx power of the D2D transmission exceeds the first preset value or the grade of the Tx power of the D2D transmission is higher than a preset grade, the base station preferentially schedules, over a corresponding radio resource, cellular transmission or D2D transmission not prone to cause interference to a cell, or schedules no transmission over a corresponding radio resource.

In an exemplary embodiment, when the D2D transmission is intra-cell transmission, the act that the base station conducts power limitation adjustment for the D2D transmission according to the D2D transmission Tx power information may include the following acts. The base station determines whether power causing interference to the D2D transmission exceeds a second preset value according to the D2D transmission Tx power information, or determines whether power expected by the D2D transmission exceeds a third preset value. When the power causing interference to the D2D transmission exceeds the second preset value or the power expected by the D2D transmission exceeds the third preset value, the base station increases a power limitation value of the D2D transmission, and schedules the D2D transmission to radio resources subjected to less interference.

In an exemplary embodiment, when the D2D transmission Tx power information includes a priority of the D2D transmission, the act that the base station conducts resource scheduling adjustment for the D2D transmission according to the D2D transmission Tx power information may include at least one of the following acts. When the priority of the D2D transmission is higher than a second preset value, the base station schedules, over a radio resource corresponding to the D2D transmission Tx power information, cellular transmission and/or D2D transmission of a cell centre UE only, or transmission at a power lower than a threshold only, or no transmission of any UE. When the priority of the D2D transmission is not higher than a second preset value, the base station schedules, over the radio resource for the D2D transmission, transmission of a cell centre UE or transmission at a power lower than a threshold or high-priority transmission of an edge UE.

In an exemplary embodiment, when the D2D transmission Tx power information includes time of duration of the D2D transmission, the act that the base station conducts power limitation adjustment or resource scheduling adjustment for the D2D transmission according to the D2D transmission Tx power information may include at least one of the following acts. The base station schedules, over a radio resource corresponding to the D2D transmission Tx power information, within the time of duration of the D2D transmission, cellular transmission and/or D2D transmission of the cell centre UE only, or transmission at a power lower than a threshold only, or no transmission of any UE, or no low-priority transmission of a UE. The base station schedules, after the time of duration of the D2D transmission, transmission of a cell edge UE over a radio resource corresponding to the D2D transmission Tx power information.

In an exemplary embodiment, the act that the base station sends the D2D transmission Tx power information to a neighbour base station of the base station may include the following acts. The base station determines a possible interference source cell and/or a possible interference source base station according to the D2D transmission Tx power information and/or D2D resource information of the neighbour base station. The base station sends the D2D transmission Tx power information to the determined possible interference source cell and/or the determined possible interference source base station.

In an exemplary embodiment, the processing centre may include at least one of: an Operation Administration and Maintenance (OAM) entity, a Mobility Management Entity (MME) or a centralized information centre.

In an exemplary embodiment, a radio resource corresponding to the D2D transmission Tx power information takes a D2D transmission resource element, or a D2D communication resource element, or a D2D Scheduling Assignment (SA) resource element, or a D2D discovery resource element, or a Physical Resource Block (PRB) as a unit.

In an exemplary embodiment, in bitmaps carried in the D2D transmission Tx power information, a length of a bitmap corresponding to D2D discovery and/or D2D communication may be identical to the number of discovery resources or SA resources or data PRBs contained in D2D resources respectively.

In an exemplary embodiment, when D2D resources of a cell of the base station are divided into parts used by D2D transmission of a cell centre UE or D2D transmission of a UE with a power lower than a threshold, and parts used by D2D transmission of a cell edge UE or D2D transmission of a UE with a power higher than a threshold, a length of a bitmap carried in the D2D transmission Tx power information may be identical to the number of resources for the D2D transmission of the cell edge UE or the D2D transmission of the UE with a power higher than a threshold.

In an exemplary embodiment, partition information of the D2D resources may be configured by means of interaction between neighbour cells, or configured by an OAM.

In an exemplary embodiment, interference state information of an existing cellular resource and the D2D transmission Tx power information may be indicated individually or indicated uniformly in one Information Element (IE).

In an exemplary embodiment, the D2D transmission Tx power information may reuse Overload Indicator (OI) information or may use a new IE for indication.

In an exemplary embodiment, the D2D transmission Tx power information may be carried in an X2 (interconnection interface between base stations) load information message.

According to another aspect of the embodiments of the present disclosure, a D2D interference coordination method is provided. In the D2D interference coordination method, a UE sends, to a base station, D2D transmission Tx power information for indicating Tx power of D2D transmission to be scheduled over a corresponding radio resource or indicating power information causing interference to D2D transmission over a corresponding radio resource. The D2D transmission Tx power information is used for indicating the base station to conduct interference coordination processing.

In an exemplary embodiment, the D2D transmission Tx power information may include at least one of: valid time of the D2D transmission Tx power information or time of duration of the D2D transmission, a group identifier of the D2D transmission, a priority of the D2D transmission, or resource information corresponding to the D2D transmission.

In an exemplary embodiment, the UE may be triggered, in one of the following modes, to send the D2D transmission Tx power information to the base station: event triggering, periodic reporting, and timer triggering.

In an exemplary embodiment, the event triggering may include the triggering under at least one of the following situations. The UE detects interference or resource conflict of D2D transmission. The UE receives a reporting request for instructing, by the base station, the UE to report the D2D transmission Tx power information. The UE has a D2D transmission resource demand or has D2D signals or data to be transmitted.

In an exemplary embodiment, the periodic reporting may include the following acts. The UE collects a degree of D2D interference corresponding to each resource granularity, and periodically reports an average value of the degree of D2D interference. A resource element of the resource granularity may include at least one of: a D2D discovery resource element, or an SA resource element, or a data resource element, or a PRB.

In an exemplary embodiment, the act that the UE sends the D2D transmission Tx power information to the base station may include the following acts. The UE reports the D2D transmission Tx power information by means of one of terminal assistance information, a measurement report, a Radio Resource Control (RRC) connection setup, a Tracking Area Update (TAU) request flow, or a new message.

According to a further aspect of the embodiments of the present disclosure, a D2D interference coordination apparatus is provided, which may be applied to a base station. The D2D interference coordination apparatus may include an acquisition module and a coordination module. The acquisition module is arranged to acquire D2D transmission Tx power information. The D2D transmission Tx power information is used for indicating Tx power of D2D transmission to be scheduled over a corresponding radio resource or indicating power information causing interference to D2D transmission over a corresponding radio resource. The coordination module is arranged to conduct interference coordination processing according to the D2D transmission Tx power information.

In an exemplary embodiment, the coordination module may include at least one of a scheduling unit, a first sending unit and a second sending unit. The scheduling unit is arranged to conduct power limitation adjustment or resource scheduling adjustment for the D2D transmission according to the D2D transmission Tx power information. The first sending unit is arranged to send the D2D transmission Tx power information to a neighbour base station of the base station. The second sending unit is arranged to send the D2D transmission Tx power information to a processing centre.

In an exemplary embodiment, the scheduling unit may include a first determination sub-unit and a scheduling sub-unit. The first determination sub-unit is arranged to determine whether the Tx power of the D2D transmission exceeds a first preset value according to the D2D transmission Tx power information, or determine a grade of the Tx power of the D2D transmission according to the D2D transmission Tx power information. The scheduling sub-unit is arranged to, when the Tx power of the D2D transmission exceeds the first preset value or the grade of the Tx power of the D2D transmission is higher than a preset grade, preferentially schedule, over a corresponding radio resource, cellular transmission or D2D transmission not prone to cause interference to a cell, or schedule no transmission over a corresponding radio resource over a corresponding radio resource.

In an exemplary embodiment, the scheduling unit may include a second determination sub-unit and a processing sub-unit. The second determination sub-unit is arranged to determine whether power causing interference to the D2D transmission exceeds a second preset value according to the D2D transmission Tx power information, or determine whether power expected by the D2D transmission exceeds a third preset value according to the D2D transmission Tx power information. The processing sub-unit is arranged to increase, when the power causing interference to the D2D transmission exceeds the second preset value or the power expected by the D2D transmission exceeds the third preset value, a power limitation value of the D2D transmission, and schedule the D2D transmission to radio resources subjected to less interference.

In an exemplary embodiment, the first sending unit may include a third determination sub-unit and a first sending sub-unit. The third determination sub-unit is arranged to determine a possible interference source cell and/or a possible interference source base station according to at least one of the D2D transmission Tx power information or D2D resource information of the neighbour base station. The first sending sub-unit is arranged to send the D2D transmission Tx power information to the determined possible interference source cell and/or the determined possible interference source base station.

In an exemplary embodiment, the acquisition module may include at least one of a receiving unit and a generation unit. The receiving unit is arranged to receive the D2D transmission Tx power information sent by a UE or a neighbour base station. The generation unit is arranged to generate the D2D transmission Tx power information according to an interference condition of radio resources.

According to yet another aspect of the embodiments of the present disclosure, a D2D interference coordination apparatus is provided, which may be applied to a UE. The D2D interference coordination apparatus may include a sending module. The sending module is arranged to send D2D transmission Tx power information for indicating Tx power of D2D transmission to be scheduled over a corresponding radio resource or indicating power information causing interference to D2D transmission over a corresponding radio resource to a base station. The D2D transmission Tx power information is used for indicating the base station to conduct interference coordination processing.

According to yet another aspect of the embodiments of the present disclosure, a base station is also provided, which may include: the D2D interference coordination apparatus applied to a base station.

According to yet another aspect of the embodiments of the present disclosure, a UE is also provided, which may include: the D2D interference coordination apparatus applied to a UE.

By means of the embodiments of the present disclosure, a base station acquires D2D transmission Tx power information, and the base station conducts interference coordination processing according to the D2D transmission Tx power information. In the embodiments, the D2D transmission Tx power information is used for indicating Tx power of D2D transmission to be scheduled over a corresponding radio resource or indicating power information causing interference to D2D transmission over a corresponding radio resource. The problem of reduced receiving performance of D2D transmission and cellular transmission due to interference or resource conflict resulted from D2D transmission between cells is solved, thus improving receiving performance and user experience.

### BRIEF DESCRIPTION OF THE DRAWINGS

The drawings illustrated herein are intended to provide understanding of the present disclosure, and form a part of the present application. The schematic embodiments and illustrations of the present disclosure are intended to explain the present disclosure, and do not form limits to the present disclosure. In the drawings:

FIG. 1 is a structural diagram of a D2D transmission network according to the related art;

FIG. 2 is a schematic diagram of a scenario in which D2D transmission and cellular transmission between neighbour cells co-exist according to the related art;

FIG. 3 is a flowchart of a D2D interference coordination method according to an embodiment of the present disclosure;

FIG. 4 is a structural diagram of a D2D interference coordination apparatus according to an embodiment of the present disclosure;

FIG. 5 is a first exemplary structural diagram of a D2D interference coordination apparatus according to an embodiment of the present disclosure;

FIG. 6 is a second exemplary structural diagram of a D2D interference coordination apparatus according to an embodiment of the present disclosure;

FIG. 7 is a third exemplary structural diagram of a D2D interference coordination apparatus according to an embodiment of the present disclosure;

FIG. 8 is a fourth exemplary structural diagram of a D2D interference coordination apparatus according to an embodiment of the present disclosure; and

FIG. 9 is a fifth exemplary structural diagram of a D2D interference coordination apparatus according to an embodiment of the present disclosure.

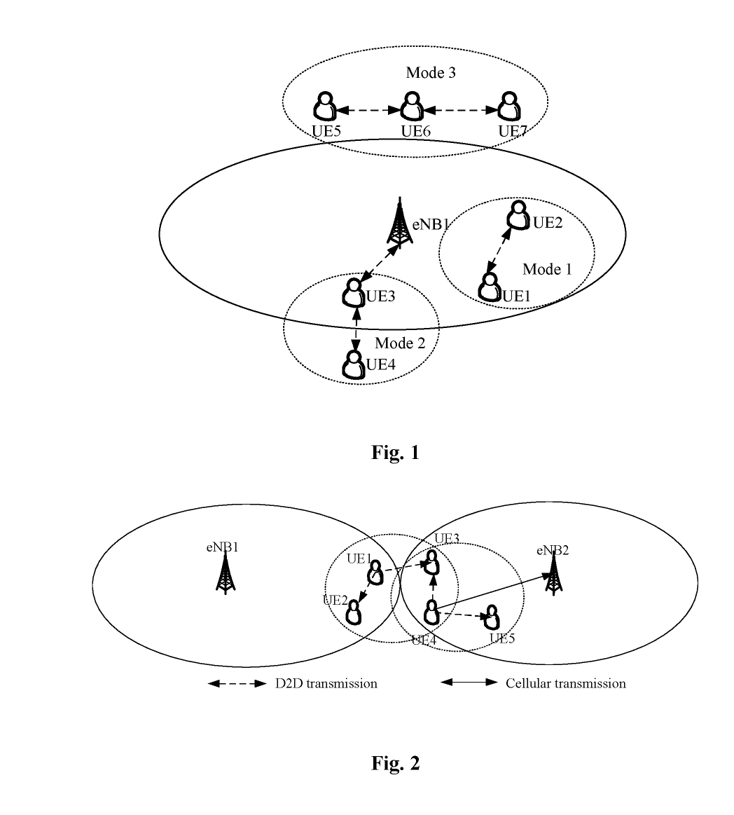

### DETAILED DESCRIPTION OF THE EMBODIMENTS

It may be appreciated that embodiments in the present application and characteristics in the embodiments may be combined under the condition of no conflicts. The present disclosure will be described hereinbelow with reference to the drawings and in conjunction with the embodiments in detail.

The acts shown in the flowchart of the drawings may be executed in a computer system including, for example, a set of computer-executable instructions. Moreover, although a logic sequence is shown in the flowchart, the shown or described acts may be executed in a sequence different from the sequence here under certain conditions.

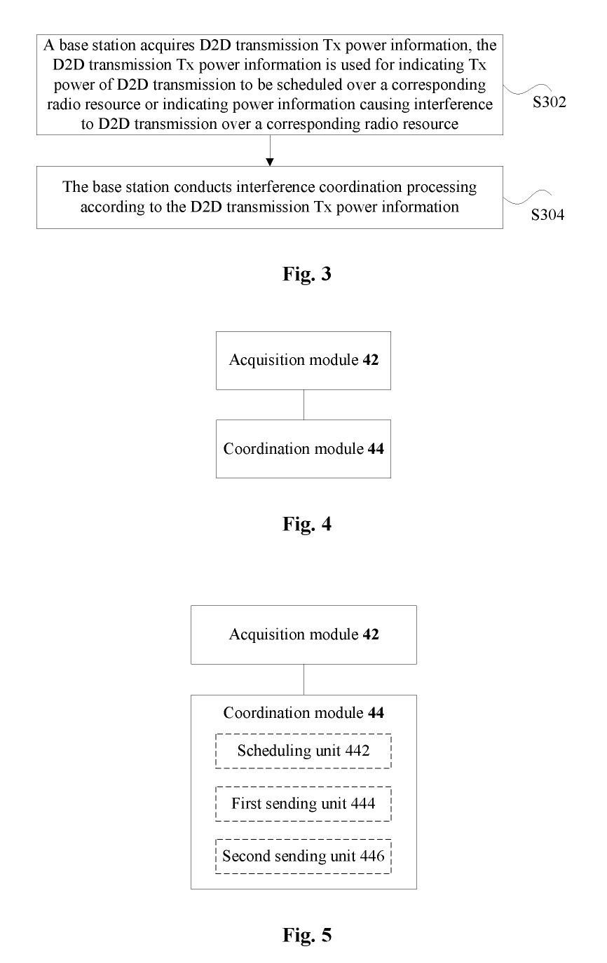

An embodiment provides a D2D interference coordination method. FIG. 3 is a flowchart of a D2D interference coordination method according to an embodiment of the present disclosure. As shown in FIG. 3, the flow may include the following acts.

At act S302, a base station acquires D2D transmission Tx power information. The D2D transmission Tx power information is used for indicating Tx power of D2D transmission to be scheduled over a corresponding radio resource or indicating power information causing interference to D2D transmission over a corresponding radio resource.

At act S304, the base station conducts interference coordination processing according to the D2D transmission Tx power information.

By means of the aforementioned method, the sending of the D2D transmission Tx power information to a base station enables the base station to perform coordination scheduling on transmission of the base station according to Tx power of D2D transmission to be scheduled. By virtue of this solution, the problem of reduced receiving performance of D2D transmission and cellular transmission due to interference or resource conflict resulted from D2D transmission between cells is solved, thus improving receiving performance and the quality of D2D communication service as well as user experience.

The information indicates power information causing interference to D2D transmission or D2D transmission Tx power information to be scheduled over a corresponding radio resource within a future period of time.

In an exemplary embodiment, the information indicates whether the Tx power of the D2D transmission exceeds a certain threshold or indicates the grade of the Tx power of the D2D transmission, for example, high, intermediate or low. Corresponding threshold values may be provided together with the information. As an alternative, the corresponding threshold may be provided by means of default configurations or other modes, for example, provided via a threshold index or a fixed default value.

In an exemplary embodiment, the D2D transmission Tx power information may include at least one of: time, a group identifier of the D2D transmission, a priority of the D2D transmission, resource information corresponding to the D2D transmission, etc. In some example embodiment, the time may indicate valid time of D2D transmission Tx power information or time of duration of the D2D transmission.

In an exemplary embodiment, after receiving the D2D transmission power information, a neighbour base station conducts corresponding interference coordination according to the information. For example, when the Tx power exceeds a certain threshold value or the power grade is high, the neighbour base station tries not to schedule, over the resource, cellular transmission or D2D transmission prone to cause interference to the D2D transmission, for example, transmission associated with a UE at a cell edge or high-power transmission (transmission at a power higher than a threshold). For example, when the Tx power does not exceed a certain threshold value or the power grade is low, the neighbour base station tries not to schedule, over the resource, cellular transmission or D2D transmission not prone to cause interference to the D2D transmission, for example, transmission associated with a UE in a cell centre or transmission at a power lower than a threshold.

In an exemplary embodiment, after receiving the D2D transmission power information, the neighbour base station conducts corresponding interference coordination according to the group identifier or priority of the D2D transmission in the information. For example, when the priority of the D2D transmission is high, the base station only schedules, over a resource corresponding to the D2D transmission power information, cellular transmission and/or D2D transmission of a cell centre UE or transmission at a power lower than a threshold, or does not schedule, over a resource corresponding to the D2D transmission power information, transmission of any UE or any low-priority transmission of a UE. When the priority is lower, the base station schedules high-priority transmission of a cell centre UE or an edge UE over a resource corresponding to the D2D transmission power information.

In an exemplary embodiment, after receiving the D2D transmission power information, the neighbour base station conducts corresponding interference coordination according to the time information of the D2D transmission in the information. For example, the base station schedules, over the radio resource corresponding to the D2D transmission power information, within the time of duration of the D2D transmission, cellular transmission and/or D2D transmission of the cell centre UE only, or transmission at a power lower than a threshold only, or no transmission of any UE, or no low-priority transmission of a UE. After corresponding time, transmission of the cell edge UE may be scheduled.

In an exemplary embodiment, a radio resource corresponding to the D2D transmission Tx power information takes a D2D transmission resource element, or a D2D communication resource element, or a D2D Scheduling Assignment (SA) resource element, or a D2D discovery resource element, or a Physical Resource Block (PRB) as a unit.

In an exemplary embodiment, different bitmaps may be further distinguished for D2D discovery and/or D2D communication. Lengths of the bitmaps may be identical to the number of discovery resources or SA resources or data PRBs contained in D2D resources. In an exemplary embodiment, the D2D transmission power information may be indicated, for example, only over a D2D resource or a D2D resource assigned to a cell edge UE.

In an exemplary embodiment, D2D resources of the cell are partitioned into resources used for D2D transmission of the cell centre UE or low-power D2D transmission (e.g., D2D transmission at a power lower than a threshold), and resources used for D2D transmission of the cell edge UE or high-power D2D transmission (e.g., D2D transmission at a power higher than a threshold). In an exemplary embodiment, the D2D transmission power information may indicate, for example, D2D transmission power information of the latter parts of resources only. In other words, the length of the bitmap may be identical to the number of resources for the D2D transmission of the cell edge UE or the high-power D2D transmission (e.g., D2D transmission at a power higher than a threshold).

In an exemplary embodiment, D2D resource partition information may be configured by means of interaction between neighbour cells, or configured by an OAM.

In an exemplary embodiment, the D2D transmission power information and the existing cellular transmission power information may be indicated individually or indicated uniformly in one IE. During uniform indication, it may be needed to indicate which information is corresponding to the D2D transmission power information. For example, D2D resource (pool) information is sent to a neighbour cell by means of inter-cell interaction or by means of OAM configuration. The neighbour cell may learn of the power information of the corresponding D2D transmission according to the information in combination with the uniformly indicated transmission power information. In an exemplary embodiment, during individual indication, the base station should ignore the received transmission power information corresponding to D2D resources in the existing cellular transmission power information.

In an exemplary embodiment, the D2D transmission power information may reuse an existing RNTP IE or may use a new IE for indication. Optionally, a corresponding D2D identifier may be added for indicating that the information is the D2D transmission power information.

In an exemplary embodiment, the D2D transmission power information may be carried in an X2 load information message.

In an exemplary embodiment, the D2D transmission power information is summarized or shared to the neighbour base station by means of an OAM or by being reported to an MME and/or a centralized information centre.

In an exemplary embodiment, the D2D transmission power information is summarized to an OAM, or to an MME and/or a centralized information centre, and the adjusted D2D transmission power is fed back to the corresponding base station.

Another embodiment of the present disclosure provides a D2D interference coordination method, which may include the following acts. A UE sends D2D transmission Tx power information for indicating Tx power of D2D transmission to be scheduled over a corresponding radio resource or indicating power information causing interference to D2D transmission over a corresponding radio resource to a base station. The D2D transmission Tx power information is used for indicating the base station to conduct interference coordination processing.

In the present embodiment, the UE reports the D2D transmission Tx power information to the base station, such that the base station conducts interference coordination processing for D2D transmission of the UE. The D2D transmission Tx power information reported by the UE may be called as D2D transmission interference power information, for indicating power information causing interference to D2D transmission or power limitation information expected for the corresponding D2D transmission.

In an exemplary embodiment, the information indicates whether Tx power causing interference to the D2D transmission exceeds a certain threshold or indicates the grade of the Tx power causing interference to the D2D transmission, for example, high, intermediate or low, or indicates whether power expected for the corresponding D2D transmission exceeds a certain threshold or power grade. Corresponding threshold values may be provided together with the information. As an alternative, the corresponding threshold may be provided by means of default configurations or other modes, for example, provided via a threshold index or a fixed default value.

In an exemplary embodiment, D2D interference sensitivity information may include at least one of: time, a group identifier of the D2D transmission, a priority of the D2D transmission, resource information corresponding to the D2D transmission, etc. In some embodiment, the time may indicate valid time of the D2D interference sensitivity information or time of duration of the D2D transmission.

In an exemplary embodiment, a D2D transmission resource element, a D2D communication resource element, a D2D SA resource element, a D2D discovery resource element or a PRB may serve as a unit of D2D transmission interference power information. Optimally, an interference condition may be reported by, for example, a D2D UE located at a cell edge only.

In an exemplary embodiment, different bitmaps may be further distinguished for D2D discovery and/or D2D communication. Lengths of the bitmaps may be identical to the number of discovery resources or SA resources or data PRBs contained in D2D resources.

In an exemplary embodiment, D2D resources of the cell are partitioned into resources used for D2D transmission of the cell centre UE or low-power D2D transmission (e.g., D2D transmission at a power lower than a threshold), and resources used for D2D transmission of the cell edge UE or high-power D2D transmission (e.g., D2D transmission at a power higher than a threshold). In an exemplary embodiment, the D2D interference state information may indicate D2D interference state information of the latter partition resources only. In other words, the length of the bitmap may be identical to the number of resources for the D2D transmission of the cell edge UE or the high-power D2D transmission (e.g., D2D transmission at a power higher than a threshold).

In an exemplary embodiment, D2D resource partition information may be configured by means of interaction between neighbour cells, or configured by an OAM.

In an exemplary embodiment, the UE may be triggered, in one of the following modes, to report the D2D transmission interference power information to the base station: event triggering, periodic reporting, and timer triggering.

In an exemplary embodiment, the event triggering may include triggering under at least one of the following situations. (1) The UE detects interference or resource conflict of D2D transmission. In an exemplary embodiment, the UE may detect interference or resource conflict of D2D transmission when monitoring or receiving D2D transmission of other UEs; or the UE detects interference or resource conflict of its own D2D transmission, and learns of, for example, this situation by monitoring or receiving feedback of the UE. (2) The UE receives a reporting request of the base station. (3) The UE has a D2D transmission resource demand or has D2D signals or data to be transmitted.

In an exemplary embodiment, the periodic reporting refers to collecting a degree of D2D interference corresponding to each resource granularity and periodically reporting an average value by the UE. A resource unit may be a D2D discovery resource element, or an SA resource element, or a data resource element, or a PRB. In an exemplary embodiment, data resources may be, for example, resources corresponding to D2D communication of interest of the UE only.

In an exemplary embodiment, the terminal may reports the D2D transmission interference power information by means of UE terminal assistance information, a measurement report, an RRC connection setup, a TAU request flow or a new message.

In an exemplary embodiment, the base station conducts interference processing according to the D2D transmission interference power information reported by the UE. In an exemplary embodiment, the interference processing may include one of the following acts.

(1) The base station conducts power limitation adjustment or resource scheduling adjustment for corresponding D2D transmission according to the D2D transmission interference power information. For example, if the corresponding D2D transmission is intra-cell transmission, the D2D transmission interference power information shows that the D2D transmission is highly interfered or the interference power is large or power expected by the UE for the corresponding D2D transmission is high, then the base station increases the power limitation value of the corresponding D2D transmission and schedules resources subjected to less interference.

(2) The base station reports the D2D transmission interference power information to a neighbour base station according to the D2D transmission interference power information reported by the UE. In an exemplary embodiment, the base station may obtain a possible interference source cell and/or a possible interference source base station according to the D2D transmission interference power information reported by the UE and/or D2D resource (pool) information of the neighbour base station. In an exemplary embodiment, reporting the D2D transmission interference power information to the neighbour base station refers to: reporting, by the base station, the D2D transmission interference power information to a possible interference source cell and/or a possible interference source base station. In an exemplary embodiment, the D2D transmission interference power information reported by the UE may contain a cell identifier and/or a base station identifier. In an exemplary embodiment, the D2D transmission interference power information indicates a condition of interference power which the corresponding D2D transmission is undergoing or expected power or power limitation for the D2D transmission.

In an exemplary embodiment, after receiving the D2D transmission interference power information, the neighbour base station conducts corresponding interference coordination according to the information. For example, when the D2D transmission interference power information is high or exceeds a certain threshold value, the neighbour base station tries not to schedule, over the resource, cellular transmission or D2D transmission prone to cause interference to the D2D transmission, for example, transmission associated with a UE at a cell edge or high-power transmission (transmission at a power higher than a threshold).

(3) The base station summarizes and/or shares the D2D transmission interference power information via an OAM or by reporting the D2D transmission interference power information to an MME and/or a centralized information centre.

In an exemplary embodiment, the D2D transmission interference power information is summarized by means of the OAM or summarized to the MME and/or the centralized information centre, and the adjusted D2D transmission power is fed back to the corresponding base station.

In an exemplary embodiment, the base station may obtain the D2D transmission interference power information of the neighbour base station via the OAM, the MME and/or the centralized information centre.

Still another embodiment provides a D2D interference coordination apparatus, which may be applied to a base station. The apparatus is arranged to implement the aforementioned D2D interference coordination method applied to a base station. FIG. 4 is a structural diagram of a D2D interference coordination apparatus according to an embodiment of the present disclosure. As shown in FIG. 4, the apparatus may include: an acquisition module 42 and a coordination module 44. The acquisition module 42 is arranged to acquire D2D transmission Tx power information. The D2D transmission Tx power information is used for indicating Tx power of D2D transmission to be scheduled over a corresponding radio resource or indicating power information causing interference to D2D transmission over a corresponding radio resource. The coordination module 44 is coupled to the acquisition module 42, and is arranged to conduct interference coordination processing according to the D2D transmission Tx power information.

It may be appreciated that the modules and the units involved in the embodiment of the present disclosure may be implemented in a software mode, or may be implemented in a hardware mode. The modules and the units described in the present embodiment may be arranged in a processor. For example, a processor may include an acquisition module 42 and a coordination module 44. It may be appreciated that the names of these modules do not form limits to the modules under certain conditions. For example, the acquisition module 42 may also be described as ‘module arranged to acquire D2D transmission Tx power information’.

The D2D interference coordination apparatus described in the apparatus embodiment corresponds to the method described in the above method embodiments. A specific implementation process thereof has been described in detail in the method embodiments, which will not be repeated.

FIG. 5 is a first exemplary structural diagram of a D2D interference coordination apparatus according to an embodiment of the present disclosure. As shown in FIG. 5, in an exemplary embodiment, the coordination module 44 may include at least one of: a scheduling unit 442, a first sending unit 444 or a second sending unit 446. The scheduling unit 442 is arranged to conduct power limitation adjustment or resource scheduling adjustment for the D2D transmission according to the transmission Tx power information. The first sending unit is arranged to send the D2D transmission Tx power information to a neighbour base station of the base station. The second sending unit is arranged to send the D2D transmission Tx power information to a processing centre.

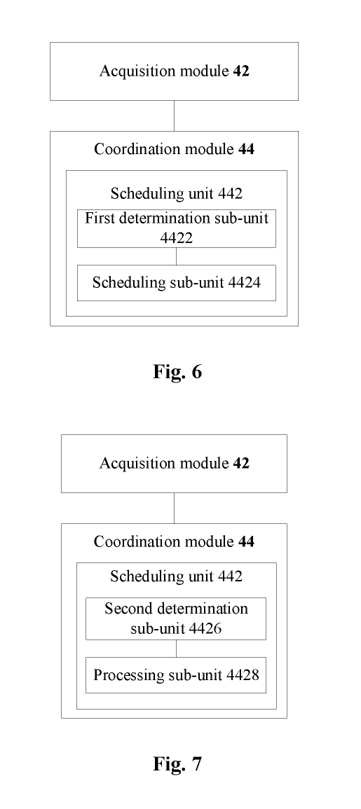

FIG. 6 is a second exemplary structural diagram of a D2D interference coordination apparatus according to an embodiment of the present disclosure. As shown in FIG. 6, in an exemplary embodiment, the scheduling unit 442 may include a first determination sub-unit 4422 and a scheduling sub-unit 4424. The first determination sub-unit 4422 is arranged to determine whether the Tx power of the D2D transmission exceeds a first preset value according to the D2D transmission Tx power information, or determine a grade of the Tx power of the D2D transmission according to the D2D transmission Tx power information. The scheduling sub-unit 4424 is coupled to the first determination sub-unit 4422 and arranged to, when the Tx power of the D2D transmission exceeds the first preset value or the grade of the Tx power of the D2D transmission is higher than a preset grade, preferentially schedule, over a corresponding radio resource, cellular transmission or D2D transmission not prone to cause interference to a cell, or schedule no transmission over a corresponding radio resource.

FIG. 7 is a third exemplary structural diagram of a D2D interference coordination apparatus according to an embodiment of the present disclosure. As shown in FIG. 7, in an exemplary embodiment, the scheduling unit 442 may further include a second determination sub-unit 4426 and a processing sub-unit 4428. The second determination sub-unit 4426 is arranged to determine whether power causing interference to the D2D transmission exceeds a second preset value according to the D2D transmission Tx power information, or determine whether power expected by the D2D transmission exceeds a third preset value according to the D2D transmission Tx power information. The processing sub-unit 4428 is coupled to the second determination sub-unit 4426 and arranged to increase, when the power causing interference to the D2D transmission exceeds the second preset value or the power expected by the D2D transmission exceeds the third preset value, a power limitation value of the D2D transmission, and schedule the D2D transmission to radio resources subjected to less interference.

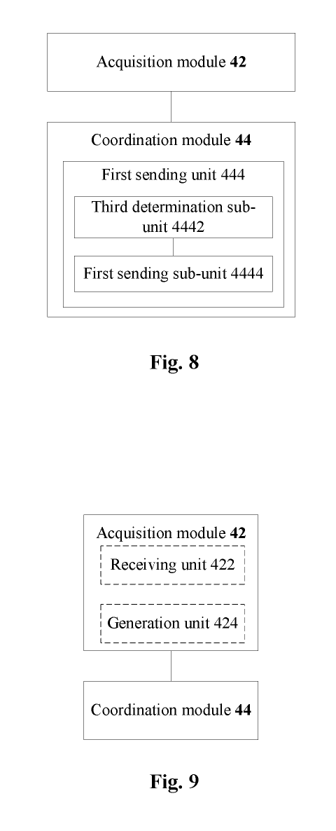

FIG. 8 is a fourth exemplary structural diagram of a D2D interference coordination apparatus according to an embodiment of the present disclosure. As shown in FIG. 8, in an exemplary embodiment, the first sending unit 444 may include a third determination sub-unit 4442 and a first sending sub-unit 4444. The third determination sub-unit 4442 is arranged to determine a possible interference source cell and/or a possible interference source base station according to at least one of the D2D transmission Tx power information or D2D resource information of the neighbour base station. The first sending sub-unit 4444 is coupled to the third determination sub-unit 4442 and arranged to send the D2D transmission Tx power information to the determined possible interference source cell and/or the determined possible interference source base station.

FIG. 9 is a fifth exemplary structural diagram of a D2D interference coordination apparatus according to an embodiment of the present disclosure. As shown in FIG. 9, in an exemplary embodiment, the acquisition module 42 may include at least one of a receiving unit 422 or a generation unit 424. The receiving unit 422 is arranged to receive the D2D transmission Tx power information sent by a UE or a neighbour base station. The generation unit 424 is arranged to generate the D2D transmission Tx power information according to an interference condition of radio resources.

Still another embodiment provides a D2D interference coordination apparatus, which may be applied to a UE. The apparatus may include a sending module. The sending module is arranged to send D2D transmission Tx power information for indicating Tx power of D2D transmission to be scheduled over a corresponding radio resource or indicating power information causing interference to D2D transmission over a corresponding radio resource to a base station. The D2D transmission Tx power information is used for indicating the base station to conduct interference coordination processing.

Still another embodiment provides a base station, which may include the D2D interference coordination apparatus applied to a base station.

Still another embodiment provides a UE, which may include the D2D interference coordination apparatus applied to a UE.

In order to make the technical solutions and the implementation method of the present disclosure clearer, the implementation process will be described in detail hereinbelow in conjunction with exemplary embodiments.

### First Method Embodiment

The present embodiment describes a method for providing, by a base station, D2D transmission Tx power information to a neighbour base station. The method may include the following acts.

At act 1, a base station provides D2D transmission Tx power information to a neighbour base station. The information indicates power information causing interference to D2D transmission or D2D transmission Tx power information to be scheduled over a corresponding radio resource within a future period of time.

In this exemplary embodiment, the information indicates whether the Tx power of the D2D transmission exceeds a certain threshold or indicates the grade of the Tx power of the D2D transmission, for example, high, intermediate or low. Corresponding threshold values may be provided together with the information. As an alternative, the corresponding threshold may be provided by means of default configurations or other modes, for example, provided via a threshold index or a fixed default value.

In this exemplary embodiment, the D2D transmission Tx power information may include at least one of: time, a group identifier of the D2D transmission, a priority of the D2D transmission, resource information corresponding to the D2D transmission, etc. In an exemplary implementation option, the time may indicate valid time of D2D transmission Tx power information or time of duration of the D2D transmission.

At act 2, after receiving the D2D transmission power information, a neighbour base station conducts corresponding interference coordination according to the information. For example, when the Tx power exceeds a certain threshold value or the power grade is high, the neighbour base station tries not to schedule, over the resource, cellular transmission or D2D transmission prone to cause interference to the D2D transmission, for example, transmission associated with a UE at a cell edge or high-power transmission (transmission at a power higher than a threshold). For example, when the Tx power does not exceed a certain threshold value or the power grade is low, the neighbour base station tries not to schedule, over the resource, cellular transmission or D2D transmission not prone to cause interference to the D2D transmission, for example, transmission associated with a UE in a cell centre or transmission at a power lower than a threshold.

In this exemplary embodiment, after receiving the D2D transmission power information, the neighbour base station conducts corresponding interference coordination according to the group identifier or priority of the D2D transmission in the information. For example, when the priority of the D2D transmission is high, the base station only schedules, over a resource corresponding to the D2D transmission power information, cellular transmission and/or D2D transmission of a cell centre UE or transmission at a power lower than a threshold, or does not schedule, over a resource corresponding to the D2D transmission power information, transmission of any UE or any low-priority transmission of a UE. When the priority is lower, the base station schedules high-priority transmission of a cell centre UE or an edge UE over a resource corresponding to the D2D transmission power information.

In this exemplary embodiment, after receiving the D2D transmission power information, the neighbour base station conducts corresponding interference coordination according to the time information of the D2D transmission in the information. For example, the base station schedules, over the radio resource corresponding to the D2D transmission power information, within the time of duration of the D2D transmission, only cellular transmission and/or D2D transmission of the cell centre UE or transmission at a power lower than a threshold or no transmission of any UE or no low-priority transmission of a UE. After corresponding time, transmission of the cell edge UE may be scheduled.

In this exemplary embodiment, a D2D transmission resource element, a D2D communication resource element, a D2D SA resource element, a D2D discovery resource element or a PRB may serve as a unit of the D2D transmission power information.

In this exemplary embodiment, different bitmaps may be further distinguished for D2D discovery and/or D2D communication. Lengths of the bitmaps may be identical to the number of discovery resources or SA resources or data PRBs contained in D2D resources. In this exemplary embodiment, the D2D transmission power information may be indicated, for example, only over a D2D resource or a D2D resource assigned to a cell edge UE.

In this exemplary embodiment, D2D resources of the cell are partitioned into resources used for D2D transmission of the cell centre UE or low-power D2D transmission (e.g., D2D transmission at a power lower than a threshold), and resources used for D2D transmission of the cell edge UE or high-power D2D transmission (e.g., D2D transmission at a power higher than a threshold). In this exemplary embodiment, the D2D transmission power information may indicate, for example, D2D transmission power information of the latter parts of resources only. In other words, the length of the bitmap may be identical to the number of resources for the D2D transmission of the cell edge UE or the high-power D2D transmission (e.g., D2D transmission at a power higher than a threshold).

In this exemplary embodiment, D2D resource partition information may be configured by means of interaction between neighbour cells, or configured by an OAM.

In this exemplary embodiment, the D2D transmission power information and the existing cellular transmission power information may be indicated individually or indicated uniformly in one IE. During uniform indication, it may be needed to indicate which information is corresponding to the D2D transmission power information. For example, D2D resource (pool) information is sent to a neighbour cell by means of inter-cell interaction or by means of OAM configuration. The neighbour cell may learn of the power information of the corresponding D2D transmission according to the information in combination with the uniformly indicated transmission power information. In this exemplary embodiment, during individual indication, the base station should ignore the received transmission power information corresponding to D2D resources in the existing cellular transmission power information.

In this exemplary embodiment, the D2D transmission power information reuses an existing RNTP IE or may use a new IE for indication. Optionally, a corresponding D2D identifier may be added for indicating that the information is the D2D transmission power information.

In this exemplary embodiment, the D2D transmission power information may be carried in an X2 load information message.

In this exemplary embodiment, the D2D transmission power information is summarized or shared to the neighbour base station by means of an OAM or by being reported to an MME and/or a centralized information centre.

### Second Method Embodiment

The present embodiment describes a method for reporting, by a UE, D2D transmission interference power information to a base station. The method may include the following acts.

At act 1, a UE reports D2D transmission interference power information to a base station. The D2D transmission interference power information indicates power information causing interference to D2D transmission or power limitation information expected for the corresponding D2D transmission. In this exemplary embodiment, the information indicates whether Tx power causing interference to the D2D transmission exceeds a certain threshold or indicates the grade of the Tx power causing interference to the D2D transmission, for example, high, intermediate or low, or indicates whether power expected for the corresponding D2D transmission exceeds a certain threshold or power grade. Corresponding threshold values may be provided together with the information. As an alternative, the corresponding threshold may be provided by means of default configurations or other modes, for example, provided via a threshold index or a fixed default value.

In this exemplary embodiment, D2D transmission Tx power information may include at least one of: time, a group identifier of the D2D transmission, a priority of the D2D transmission, resource information corresponding to the D2D transmission, etc. In an exemplary implementation option, the time may indicate valid time of the Tx power of the D2D transmission or time of duration of the D2D transmission.

At act 2, the base station conducts interference processing according to the D2D transmission interference power information reported by the UE. In this exemplary embodiment, the interference processing may include one of the following acts.

(1) The base station conducts power limitation adjustment or resource scheduling adjustment for corresponding D2D transmission according to the D2D transmission interference power information. For example, if the corresponding D2D transmission is intra-cell transmission, the D2D transmission interference power information shows that the D2D transmission is highly interfered or the interference power is large or power expected by the UE for the corresponding D2D transmission is high, then the base station increases the power limitation value of the corresponding D2D transmission and schedules resources subjected to less interference.

(2) The base station reports the D2D transmission interference power information to a neighbour base station according to the D2D transmission interference power information reported by the UE. In this exemplary embodiment, the base station may obtain a possible interference source cell and/or a possible interference source base station according to the D2D transmission interference power information reported by the UE and/or D2D resource (pool) information of the neighbour base station. In this exemplary embodiment, reporting the D2D transmission interference power information to the neighbour base station refers to: reporting, by the base station, the D2D transmission interference power information to a possible interference source cell and/or a possible interference source base station. In this exemplary embodiment, the D2D transmission interference power information indicates a condition of interference power which the corresponding D2D transmission is undergoing or expected power or power limitation for the D2D transmission.

(3) The base station summarizes and/or shares the D2D transmission interference power information reported by the UE via an OAM or by reporting the D2D transmission interference power information to an MME and/or a centralized information centre.

In this exemplary embodiment, a D2D transmission resource element, a D2D communication resource element, a D2D SA resource element, a D2D discovery resource element or a PRB may serve as a unit of D2D transmission interference power information.

In this exemplary embodiment, different bitmaps may be further distinguished for D2D discovery and/or D2D communication. Lengths of the bitmaps may be identical to the number of discovery resources or SA resources or data PRBs contained in D2D resources.

In this exemplary embodiment, D2D resources of the cell are partitioned into resources used for D2D transmission of the cell centre UE or low-power D2D transmission (e.g., D2D transmission at a power lower than a threshold), and resources used for D2D transmission of the cell edge UE or high-power D2D transmission (e.g., D2D transmission at a power higher than a threshold). In this exemplary embodiment, the D2D interference state information may indicate D2D interference state information of the latter partition resources only. In other words, the length of the bitmap may be identical to the number of resources for the D2D transmission of the cell edge UE or the high-power D2D transmission (e.g., D2D transmission at a power higher than a threshold).

In this exemplary embodiment, D2D resource partition information may be configured by means of interaction between neighbour cells, or configured by an OAM.

In this exemplary embodiment, the UE may be triggered, in one of the following modes, to report the D2D transmission interference power information to the base station: event triggering, periodic reporting, and timer triggering.

In this exemplary embodiment, the event triggering may include triggering under at least one of the following situations. (1) The UE detects interference or resource conflict of D2D transmission. In this exemplary embodiment, the UE may detect interference or resource conflict of D2D transmission when monitoring or receiving D2D transmission of other UEs; or the UE detects interference or resource conflict of its own D2D transmission, and learns of, for example, this situation by monitoring or receiving feedback of the UE. (2) The UE receives a reporting request of the base station. (3) The UE has a D2D transmission resource demand or has D2D signals or data to be transmitted.

In this exemplary embodiment, the periodic reporting refers to collecting a degree of D2D interference corresponding to each resource granularity and periodically reporting an average value by the UE. A resource unit may be a D2D discovery resource element, or an SA resource element, or a data resource element, or a PRB. In this exemplary embodiment, data resources may be, for example, resources corresponding to D2D communication of interest of the UE only.

In this exemplary embodiment, the terminal may reports the D2D transmission interference power information by means of UE terminal assistance information, a measurement report, an RRC connection setup, a TAU request flow or a new message.

In this exemplary embodiment, the base station may obtain the D2D transmission interference power information of the neighbour base station via the OAM, the MME and/or the centralized information centre.

### Third Method Embodiment

The present embodiment describes a method for reporting, by a UE, D2D transmission interference power information to a base station and conducting interference coordination in a manner of providing, by the base station, the D2D interference state information to a neighbour base station after the base station receives the information. The method may include the following acts.

At act 1, a UE reports D2D transmission interference power information to a base station. The D2D transmission interference power information indicates power information causing interference to D2D transmission or power limitation information expected for the corresponding D2D transmission. In this exemplary embodiment, the information indicates whether Tx power causing interference to the D2D transmission exceeds a certain threshold or indicates the grade of the Tx power causing interference to the D2D transmission, for example, high, intermediate or low, or indicates whether power expected for the corresponding D2D transmission exceeds a certain threshold or power grade. Corresponding threshold values may be provided together with the information. As an alternative, the corresponding threshold may be provided by means of default configurations or other modes, for example, provided via a threshold index or a fixed default value.

In this exemplary embodiment, D2D transmission Tx power information may include at least one of: time, a group identifier of the D2D transmission, a priority of the D2D transmission, resource information corresponding to the D2D transmission, etc. In an exemplary implementation option, the time may indicate valid time of the Tx power of the D2D transmission or time of duration of the D2D transmission.

At act 2, after receiving the information, the base station reports the D2D transmission interference power information to a neighbour base station. In this exemplary embodiment, the base station may obtain a possible interference source cell and/or a possible interference source base station according to the D2D transmission interference power information reported by the UE and/or D2D resource (pool) information of the neighbour base station. In this exemplary embodiment, reporting the D2D transmission interference power information to the neighbour base station refers to: reporting, by the base station, the D2D transmission interference power information to a possible interference source cell and/or a possible interference source base station. In this exemplary embodiment, the D2D transmission interference power information indicates a condition of interference power which the corresponding D2D transmission is undergoing or expected power or power limitation for the D2D transmission.

In this exemplary embodiment, the base station summarizes and/or shares the D2D transmission interference power information reported by the UE via an OAM or by reporting the D2D transmission interference power information to an MME and/or a centralized information centre.

At act 3, after receiving the D2D transmission interference power information, the neighbour base station conducts corresponding interference coordination according to the information. For example, when the D2D transmission interference power information is high or exceeds a certain threshold value, the neighbour base station tries not to schedule, over the resource, cellular transmission or D2D transmission prone to cause interference to the D2D transmission, for example, transmission associated with a UE at a cell edge or high-power transmission (transmission at a power higher than a threshold).

In this exemplary embodiment, a D2D transmission resource element, a D2D communication resource element, a D2D SA resource element, a D2D discovery resource element or a PRB may serve as a unit of the D2D transmission power information. Optimally, an interference condition may be reported by, for example, a D2D UE located at a cell edge only.

In this exemplary embodiment, different bitmaps may be further distinguished for D2D discovery and/or D2D communication. Lengths of the bitmaps may be identical to the number of discovery resources or SA resources or data PRBs contained in D2D resources.

In this exemplary embodiment, D2D resources of the cell are partitioned into resources used for D2D transmission of the cell centre UE or low-power D2D transmission (e.g., D2D transmission at a power lower than a threshold), and resources used for D2D transmission of the cell edge UE or high-power D2D transmission (e.g., D2D transmission at a power higher than a threshold). In this exemplary embodiment, the D2D transmission power information may indicate, for example, D2D transmission power information of the latter parts of resources only. In other words, the length of the bitmap may be identical to the number of resources for the D2D transmission of the cell edge UE or the high-power D2D transmission (e.g., D2D transmission at a power higher than a threshold).

In this exemplary embodiment, D2D resource partition information may be configured by means of interaction between neighbour cells, or configured by an OAM.

In this exemplary embodiment, the UE may be triggered, in one of the following modes, to report the D2D transmission interference power information to the base station: event triggering, periodic reporting, and timer triggering.

In this exemplary embodiment, the event triggering may include triggering under at least one of the following situations. (1) The UE detects interference or resource conflict of D2D transmission. In this exemplary embodiment, the UE may detect interference or resource conflict of D2D transmission when monitoring or receiving D2D transmission of other UEs; or the UE detects interference or resource conflict of its own D2D transmission, and learns of, for example, this situation by monitoring or receiving feedback of the UE. (2) The UE receives a reporting request of the base station. (3) The UE has a D2D transmission resource demand or has D2D signals or data to be transmitted.

In this exemplary embodiment, the periodic reporting refers to collecting a degree of D2D interference corresponding to each resource granularity and periodically reporting an average value by the UE. A resource unit may be a D2D discovery resource element, or an SA resource element, or a data resource element, or a PRB. In this exemplary embodiment, data resources may be, for example, resources corresponding to D2D communication of interest of the UE only.

In this exemplary embodiment, the terminal may reports the D2D transmission interference power information by means of UE terminal assistance information, a measurement report, an RRC connection setup, a TAU request flow or a new message.

In this exemplary embodiment, the base station may obtain the D2D transmission interference power information of the neighbour base station via the OAM, the MME and/or the centralized information centre.

### Fourth Method Embodiment

The present embodiment describes a method for reporting, by a UE, D2D transmission interference power information to a base station and conducting interference coordination after the base station receives the information. The method may include the following acts.

At act 1, a UE reports D2D transmission interference power information to a base station. The D2D transmission interference power information indicates power information causing interference to D2D transmission or power limitation information expected for the corresponding D2D transmission. In this exemplary embodiment, the information indicates whether Tx power causing interference to the D2D transmission exceeds a certain threshold or indicates the grade of the Tx power causing interference to the D2D transmission, for example, high, intermediate or low, or indicates whether power expected for the corresponding D2D transmission exceeds a certain threshold or power grade. Corresponding threshold values may be provided together with the information. As an alternative, the corresponding threshold may be provided by means of default configurations or other modes, for example, provided via a threshold index or a fixed default value.

At act 2, after receiving the information, the base station conducts resource assignment or scheduling adjustment or power adjustment for corresponding D2D transmission according to the D2D transmission interference power information. For example, if the corresponding D2D transmission is intra-cell transmission, the D2D transmission interference power information shows that the D2D transmission is highly interfered or the interference power is large or power expected by the UE for the corresponding D2D transmission is high, then the base station assigns or schedules other resources or resources not prone to cause interference to the corresponding D2D transmission, or increases the Tx power of the corresponding D2D transmission and schedules resources subjected to less interference.

In this exemplary embodiment, D2D transmission Tx power information may include at least one of: time, a group identifier of the D2D transmission, a priority of the D2D transmission, resource information corresponding to the D2D transmission, etc. In an exemplary implementation option, the time may indicate valid time of the Tx power of the D2D transmission or time of duration of the D2D transmission.

In this exemplary embodiment, a D2D transmission resource element, a D2D communication resource element, a D2D SA resource element, a D2D discovery resource element or a PRB may serve as a unit of D2D transmission interference power information.

In this exemplary embodiment, different bitmaps may be further distinguished for D2D discovery and/or D2D communication. Lengths of the bitmaps may be identical to the number of discovery resources or SA resources or data PRBs contained in D2D resources.

In this exemplary embodiment, D2D resources of the cell are partitioned into resources used for D2D transmission of the cell centre UE or low-power D2D transmission (e.g., D2D transmission at a power lower than a threshold), and resources used for D2D transmission of the cell edge UE or high-power D2D transmission (e.g., D2D transmission at a power higher than a threshold). In this exemplary embodiment, the D2D interference state information may indicate D2D interference state information of the latter partition resources only. In other words, the length of the bitmap may be identical to the number of resources for the D2D transmission of the cell edge UE or the high-power D2D transmission (e.g., D2D transmission at a power higher than a threshold).

In this exemplary embodiment, D2D resource partition information may be configured by means of interaction between neighbour cells, or configured by an OAM.

In this exemplary embodiment, the UE may be triggered, in one of the following modes, to report the D2D transmission interference power information to the base station: event triggering, periodic reporting, and timer triggering.

In this exemplary embodiment, the event triggering may include triggering under at least one of the following situations. (1) The UE detects interference or resource conflict of D2D transmission. In this exemplary embodiment, the UE may detect interference or resource conflict of D2D transmission when monitoring or receiving D2D transmission of other UEs; or the UE detects interference or resource conflict of its own D2D transmission, and learns of, for example, this situation by monitoring or receiving feedback of the UE. (2) The UE receives a reporting request of the base station. (3) The UE has a D2D transmission resource demand or has D2D signals or data to be transmitted.

In this exemplary embodiment, the periodic reporting refers to collecting a degree of D2D interference corresponding to each resource granularity and periodically reporting an average value by the UE. A resource unit may be a D2D discovery resource element, or an SA resource element, or a data resource element, or a PRB. In this exemplary embodiment, data resources may be, for example, resources corresponding to D2D communication of interest of the UE only.

In this exemplary embodiment, the terminal may reports the D2D transmission interference power information by means of UE terminal assistance information, a measurement report, an RRC connection setup, a TAU request flow or a new message.

In conclusion, the abovementioned embodiments, exemplary embodiments and implementation modes of the present disclosure solve the problem of interference or resource conflict of D2D transmission between neighbour cells in D2D discovery or D2D communication and the problem of interference or resource conflict between D2D transmission and cellular transmission. Compared with the related art, the method and system of the embodiments of the present disclosure can provide a targeted interference or conflict solving method according to a policy and a priority during practical application of D2D transmission, thereby improving the quality of D2D services and user experience.

Industrial applicability: the abovementioned embodiments of the present disclosure solve the problem of reduced receiving performance of D2D transmission and cellular transmission due to interference or resource conflict resulted from D2D transmission between cells, thus improving receiving performance.

Obviously, those skilled in the art shall understand that all of the abovementioned modules or acts in the present disclosure may be implemented by using a general calculation apparatus, may be centralized on a single calculation apparatus or may be distributed on a network composed of a plurality of calculation apparatuses. Alternatively, they may be implemented by using executable program codes of the calculation apparatuses. Thus, they may be stored in a storage apparatus and executed by the calculation apparatuses, or they are manufactured into each integrated circuit module respectively, or multiple modules or acts therein are manufactured into a single integrated circuit module. Thus, the present disclosure is not limited to a combination of any specific hardware and software.

The above is only the exemplary embodiments of the present disclosure, and not intended to limit the present disclosure. There may be various modifications and variations in the present disclosure for those skilled in the art. Any modifications, equivalent replacements, improvements and the like made within the principle of the present disclosure shall fall within the scope of protection of the present disclosure.

1. A Device-to-Device (D2D) interference coordination method, comprising:
acquiring, by a base station, D2D transmission Tx power information, wherein the D2D transmission Tx power information is used for indicating Tx power of D2D transmission to be scheduled over a corresponding radio resource or indicating power information causing interference to D2D transmission over a corresponding radio resource; and
conducting, by the base station, interference coordination processing according to the D2D transmission Tx power information.

2. The method as claimed in claim 1, wherein acquiring, by the base station, the D2D transmission Tx power information comprises at least one of:
receiving, by the base station, the D2D transmission Tx power information sent by a User Equipment (UE) or a neighbour base station; or
generating, by the base station, the D2D transmission Tx power information according to an interference condition of radio resources.

3. The method as claimed in claim 1, wherein the D2D transmission Tx power information comprises at least one of:
valid time of the D2D transmission Tx power information or time of duration of the D2D transmission, a group identifier of the D2D transmission, a priority of the D2D transmission, or resource information corresponding to the D2D transmission.

4. The method as claimed in claim 1, wherein conducting interference coordination processing according to the D2D transmission Tx power information comprises at least one of:
conducting, by the base station, power limitation adjustment or resource scheduling adjustment for the D2D transmission according to the D2D transmission Tx power information;
sending, by the base station, the D2D transmission Tx power information to a neighbour base station of the base station; or
sending, by the base station, the D2D transmission Tx power information to a processing centre.

5. The method as claimed in claim 4, wherein
conducting, by the base station, resource scheduling adjustment for the D2D transmission according to the D2D transmission Tx power information comprises:
determining, by the base station, whether the Tx power of the D2D transmission exceeds a first preset value according to the D2D transmission Tx power information, or determining, by the base station, a grade of the Tx power of the D2D transmission according to the D2D transmission Tx power information; and
when the Tx power of the D2D transmission exceeds the first preset value or the grade of the Tx power of the D2D transmission is higher than a preset grade, preferentially scheduling, by the base station, cellular transmission or D2D transmission, which is not prone to cause interference to a cell, over a corresponding radio resource, or scheduling, by the base station, no transmission over a corresponding radio resource;
or,
when the D2D transmission is intra-cell transmission, conducting, by the base station, power limitation adjustment for the D2D transmission according to the D2D transmission Tx power information comprises: determining, by the base station, whether power causing interference to the D2D transmission exceeds a second preset value according to the D2D transmission Tx power information, or determining, by the base station, whether power expected by the D2D transmission exceeds a third preset value according to the D2D transmission Tx power information; and when the power causing interference to the D2D transmission exceeds the second preset value or the power expected by the D2D transmission exceeds the third preset value, increasing, by the base station, a power limitation value of the D2D transmission, and scheduling, by the base station, the D2D transmission to radio resources subjected to less interference;
or,
when the D2D transmission Tx power information comprises a priority of the D2D transmission, conducting, by the base station, resource scheduling adjustment for the D2D transmission according to the D2D transmission Tx power information comprises at least one of: when the priority of the D2D transmission is higher than a second preset value, scheduling, by the base station over a radio resource corresponding to the D2D transmission Tx power information, at least one of cellular transmission or D2D transmission of a cell centre UE only, or transmission at a power lower than a threshold only, or no transmission of any UE; or when the priority of the D2D transmission is not higher than the second preset value, scheduling, by the base station over a radio resource for the D2D transmission, transmission of a cell centre UE or transmission at a power lower than a threshold or high-priority transmission of an edge UE;
or,
when the D2D transmission Tx power information comprises time of duration of the D2D transmission, conducting, by the base station, power limitation adjustment or resource scheduling adjustment for the D2D transmission according to the D2D transmission Tx power information comprises at least one of: scheduling, by the base station over a radio resource corresponding to the D2D transmission Tx power information, within the time of duration of the D2D transmission, at least one of cellular transmission or D2D transmission of a cell centre UE only, or transmission at a power lower than a threshold only, or no transmission of any UE, or no low-priority transmission of a UE; or scheduling, by the base station, after the time of duration of the D2D transmission, transmission of a cell edge UE over a radio resource corresponding to the D2D transmission Tx power information.

6. (canceled)

7. (canceled)

8. (canceled)

9. The method as claimed in claim 4, wherein sending, by the base station, the D2D transmission Tx power information to the neighbour base station of the base station comprises:
determining, by the base station, at least one of a possible interference source cell or a possible interference source base station according to at least one of the D2D transmission Tx power information or D2D resource information of the neighbour base station; and
sending, by the base station, the D2D transmission Tx power information to at least one of the determined possible interference source cell or the determined possible interference source base station.

10. The method as claimed in claim 4, wherein the processing centre comprises at least one of:
an Operation Administration and Maintenance (OAM) entity, a Mobility Management Entity (MME) or a centralized information centre.

11. The method as claimed in claim 1, wherein a radio resource corresponding to the D2D transmission Tx power information takes a D2D transmission resource element, or a D2D communication resource element, or a D2D Scheduling Assignment (SA) resource element, or a D2D discovery resource element, or a Physical Resource Block (PRB) as a unit.

12. The method as claimed in claim 11, wherein in bitmaps carried in the D2D transmission Tx power information, a length of a bitmap corresponding to at least one of D2D discovery or D2D communication is identical to the number of discovery resources or SA resources or data PRBs contained in D2D resources respectively.

13. The method as claimed in claim 11, wherein when D2D resources of a cell of the base station are divided into parts used by D2D transmission of a cell centre UE or D2D transmission of a UE with a power lower than a threshold, and parts used by D2D transmission of a cell edge UE or D2D transmission of a UE with a power higher than a threshold, a length of a bitmap carried in the D2D transmission Tx power information is identical to the number of resources for the D2D transmission of the cell edge UE or the D2D transmission of the UE with the power higher than the threshold.

14. The method as claimed in claim 13, wherein partition information of the D2D resources is configured by means of interaction between neighbour cells, or configured by an Operation Administration and Maintenance (OAM).

15. The method as claimed in claim 1, wherein
interference state information of an existing cellular resource and the D2D transmission Tx power information are indicated individually or indicated uniformly in one Information Element (IE);
or,
the D2D transmission Tx power information reuses Overload Indicator (OI) information or uses a new Information Element (IE) for indication;
or,
the D2D transmission Tx power information is carried in an X2 load information message.

16. (canceled)

17. (canceled)

18. A Device-to-Device (D2D) interference coordination method, comprising:
sending, by a User Equipment (UE) to a base station, D2D transmission Tx power information for indicating Tx power of D2D transmission to be scheduled over a corresponding radio resource or indicating power information causing interference to D2D transmission over a corresponding radio resource, wherein the D2D transmission Tx power information is used for indicating the base station to conduct interference coordination processing.

19. The method as claimed in claim 18, wherein the D2D transmission Tx power information comprises at least one of:
valid time of the D2D transmission Tx power information or time of duration of the D2D transmission, a group identifier of the D2D transmission, a priority of the D2D transmission, or resource information corresponding to the D2D transmission.

20. The method as claimed in claim 18, wherein
the UE is triggered, in one of the following modes, to send the D2D transmission Tx power information to the base station:
event triggering, periodic reporting, and timer triggering;
or,
sending, by the UE, the D2D transmission Tx power information to the base station comprises:
reporting, by the UE, the D2D transmission Tx power information by means of one of terminal assistance information, a measurement report, a Radio Resource Control (RRC) connection setup, a Tracking Area Update (TAU) request flow, or a new message.

21. The method as claimed in claim 20, wherein
the event triggering comprises at least one of:
detecting, by the UE, interference or resource conflict of D2D transmission;
receiving, by the UE, a reporting request for instructing, by the base station, the UE to report the D2D transmission Tx power information; or
having, by the UE, a D2D transmission resource demand or D2D signals or data to be transmitted;
or,
the periodic reporting comprises:
collecting, by the UE, a degree of D2D interference corresponding to each resource granularity, and periodically reporting, by the UE, an average value of the degree of D2D interference, wherein a resource element of the resource granularity comprises at least one of: a D2D discovery resource element, or a Scheduling Assignment (SA) resource element, or a data resource element, or a Physical Resource Block (PRB).

22. (canceled)

23. (canceled)

24. A Device-to-Device (D2D) interference coordination apparatus, applied to a base station, the apparatus comprising a hardware processing arranged to execute program modules comprising:
an acquisition module, arranged to acquire D2D transmission Tx power information, wherein the D2D transmission Tx power information is used for indicating Tx power of D2D transmission to be scheduled over a corresponding radio resource or indicating power information causing interference to D2D transmission over a corresponding radio resource; and
a coordination module, arranged to conduct interference coordination processing according to the D2D transmission Tx power information.

25. (canceled)

26. (canceled)

27. (canceled)

28. (canceled)

29. (canceled)

30. A Device-to-Device (D2D) interference coordination apparatus, applied to a User Equipment (UE), the apparatus comprising a hardware processing arranged to execute:
a sending module, arranged to send, to a base station, D2D transmission Tx power information for indicating Tx power of D2D transmission to be scheduled over a corresponding radio resource or indicating power information causing interference to D2D transmission over a corresponding radio resource, wherein the D2D transmission Tx power information is used for indicating the base station to conduct interference coordination processing.

31. A base station, comprising: the D2D interference coordination apparatus as claimed in claim 24.

32. A User Equipment (UE), comprising: the D2D interference coordination apparatus as claimed in claim 30.
